(19) United States
(12) Patent Application Publication
(10) Pub. No.: US 2003/0050856 A1
(43) Pub. Date: Mar. 13, 2003

(54) Process and system for purchasing goods and services through a distributed data network

(76) Inventors: Massimiliano Rijllo, Messina (IT); Emanuele Gagliano, Comiso (IT); Giovanni Privitera, Messina (IT)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(21) Appl. No.: 10/234,421

(22) Filed: Sep. 3, 2002

Related U.S. Application Data
(63) Continuation of application No. PCT/IT01/00101, filed on Mar. 2, 2001.

(30) Foreign Application Priority Data
Mar. 3, 2000 (IT) PI2000A 000011

(51) Int. Cl. G06F 17/60

(52) U.S. Cl. 705/26

(57) ABSTRACT

Process for purchasing goods and services (6) through a distributed data network (3), which comprises the following operative steps:

a computer (5) of a seller (4) receives an order of at least one item or service (6) from a device (2) of a user (1) for accessing to the distributed data network (3); a computer (5) of the seller (4) sends through the distributed data network (3) data (P) of the item or service (6) ordered by the user (1) to a computer (10) of a broker (9); the access device (2) of the user (1) sends at least one identification code (7) of the user (1); a computer (10; 19) of a broker (9; 18) receives the identification code (7) of the user (1) and obtains from a database (11) the number of a mobile telephone (12) according to said identification code (7);

a computer (15; 19) of a broker (9; 18) dials the number obtained from the database (11) and calls the relevant mobile telephone (12) through a mobile telephone network (14); a computer (15; 19) of a broker (9; 18) asks for a confirmation of said order of the user (1) through the called telephone (12);

a computer (10) of a broker (9) sends through the distributed data network (3) a confirmation or a cancellation of the order of the user (1) to a computer (5) of the seller (4) according to the answer, if any, obtained through the called telephone (12).

The present invention also relates to a system that carries out said process.

### CROSS-REFERENCE TO RELATED APPLICATIONS

This application is a continuation of International Patent Application No. PCT/IT01/00101, filed Mar. 2, 2001, which was published in the English language on Sep. 7, 2001, under International Publication No. WO 01/65432, and the disclosure of which is incorporated herein by reference.

### BACKGROUND OF THE INVENTION

The present invention relates to a process for purchasing goods and services through a distributed data network, and in particular a process allowing a client to order and pay goods and services through Internet at a high security level. The present invention also relates to a system that carries out said process.

Processes and systems for purchasing goods and services are known, wherein a computer of a seller receives through Internet an order from a network access device of a user and sends, always through Internet, an identification code of the user and data of the item or service ordered by the user to a computer of a broker, which provides for debiting the user with the price of the item or service and crediting the seller with the same amount, reduced by a service charge, if desired.

However, for confirming his own order, the user must communicate to the seller the data for accessing to a credit account, for instance data of his own credit card, which, even if they are encrypted with sophisticated techniques, can always be intercepted by ill-intentioned persons for being used in an illegal way.

### BRIEF SUMMARY OF THE INVENTION

It is therefore an object of the present invention to provide a process and a system for purchasing goods and services through a distributed data network, which are free from said disadvantages, i.e. offer a security level higher than the level offered by the known processes and systems. Said object is achieved with a process and a system the main features of which are specified in claims 1 and 7 respectively, while other features are specified in the remaining claims.

The process according to the present invention provides for a high security level thanks to the use of two different communication networks for carrying out the transaction. The first network, for instance Internet, is employed for choosing and requesting the item or service, while the second one, i.e. the mobile telephone network, is employed for the confirmation, if any, of the transaction. Each transaction is secure thanks to the direct confirmation of the user through a mobile telephone, since this confirmation does not go through the distributed network and therefore cannot be intercepted by ill-intentioned persons.

Furthermore, the user telephone, being mobile, is provided with an internal security code which is generally inserted into a SIM card which is difficult to be cloned, so that, unlike the fixed telephones, in cannot be deviated to another telephone without the consent of the user himself.

The process according to the present invention is as well secure since the user does not have to communicate data relating to a credit account for the debit. For instance, the user does not have to provide the number of his own credit card for purchasing an item or a service.

Another advantage of the process according to the present invention lies in the possibility of being carried out in an entirely automatic way through a system comprising some known means, for instance a network of computers mutually connected through a LAN or WAN network. With this arrangement the times and the costs for creating and maintaining the system itself are decreased.

The process according to the present invention does not need the transmission in the system of the personal user data. which are stored in a single data base, distributed, if desired, among more computers connected in a network, which are preferably connected each other by means of private networks, for instance LAN or WAN. The privacy level with respect to the known processes is therefore increased, since even the seller can be kept in the dark about the user identity.

A further advantage of the process according to the present invention lies in the possibility for the user of obtaining the order confirmation request in a deferred way and with means, i.e. the mobile telephone, which are simpler to use and more widespread than the Internet access devices, so that the user can confirm his own order in a second time even if he is not connected to the network. Further, through the mobile telephones of the UMTS or GSM kind with WAP or GPRS protocol, which allow the connection to Internet and to a mobile telephone network, the user can employ a single device for executing and confirming the order.

According to a particular aspect of the invention, the system can comprise two brokers, both provided with a computer for receiving and transmitting the order data of the user. With this arrangement the operative steps of the process according to the present invention are divided among more entities, with consequent optimization of the system resources and increase of the security level.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

In the drawings:

FIG. 1 shows a block scheme of a first embodiment of said system;

FIG. 2 shows a flow chart of the process carried out by the system of FIG. 1;

FIG. 3 shows a block scheme of a second embodiment of said system; and

FIG. 4 shows a flow chart of the process carried out by the system of FIG. 3.

### DETAILED DESCRIPTION OF THE INVENTION

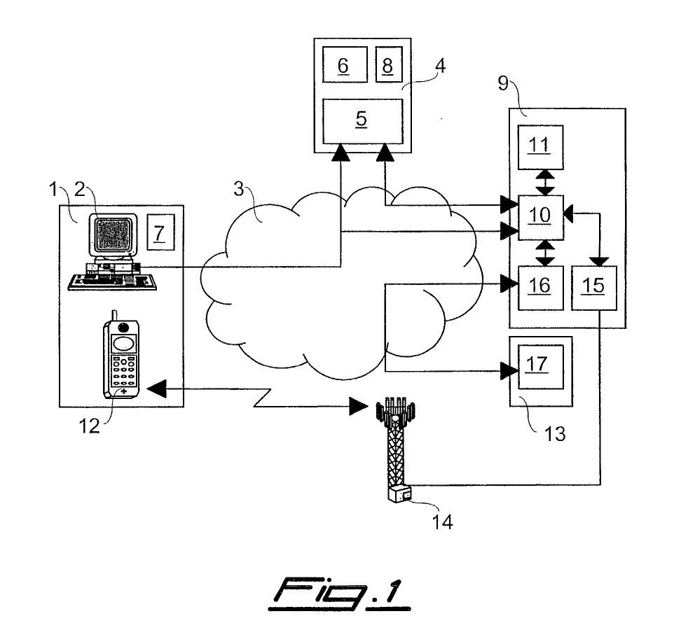

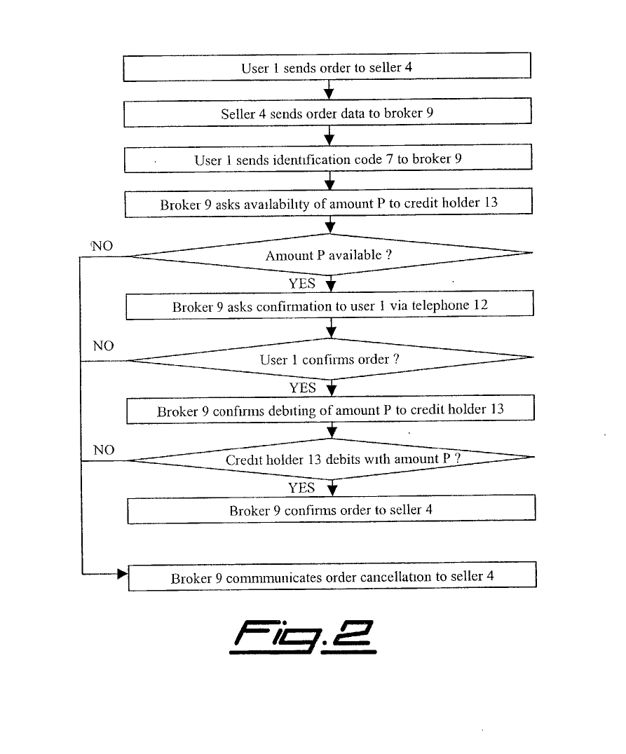

Referring to FIGS. 1 and 2, it is seen that in the process and in the system according to a first embodiment of the invention a user 1 is provided in a known way with a device 2 for accessing to a distributed data network 3 of computers, for instance Internet. Said access device 2 can be for instance a personal computer, a GSM mobile telephone provided with WAP or GPRS technology, a UMTS mobile telephone, a web television, each provided with the relevant communication software or firmware. Through the access device 2 user 1 can contact a seller 4, for instance through an email message or one or more hypertext pages of a website hosted in at least one computer 5 connected to network 3. User 1 can thus choose and order in a known way an item or a service 6 offered by seller 4 at a price P. User 1 can identify himself to seller 4 as in the known processes or remain anonymous. Seller 4, once he receives the order of user 1, sends his own data 8 and the order data, in particular the price P of the item or service 6 preferably provided with a short description thereof, to a broker 9 provided with at least one computer 10 connected to network 3. User 1 is contemporaneously connected to broker 9 and identifies himself to the latter by communicating an identification code 7, for instance a login associated with a password. Thanks to this contemporaneous connection, obtained for example by means of a link from a hypertext page of the site of seller 4, broker 9 can therefore associate the data coming from seller 4 and relating to an order which can still be anonymous, with user 1, which identifies himself with code 7 and therefore is considered the executor of the order.

Broker 9 is suitably provided with a database 11 in which the identification code 7 of user 1 is associated with his personal data, in particular the number of a mobile telephone 12, for instance of the E-TACS, DECT, GSM or UMTS kind, which is preferably provided with a SIM card wherein a security code associated with the number of the same telephone is stored. Said personal data associated in database 11 with the identification code 7 of user 1 preferably comprise also data for accessing to a credit account with a credit holder 13, for instance the bank or the provider of the credit card of user 1, which can be previously sent from user 1 to broker 9, for example by hand, mail or also through network 3.

Broker 9 preferably asks to the credit holder 13 the availability of an amount, in particular equal to the price P of item or service 6, and in case of a positive answer suitably requests a confirmation of the order of item or service 6 to user 1 by connecting to his mobile telephone 12 through a mobile telephone network 14, after having obtained from database 11 the number of the same telephone according to the identification code 7. Said confirmation request can consist of a SMS text and/or voice message comprising amount P and preferably other order data, for instance the data of seller 4 and/or of item or service 6. The vocal communication between broker 9 and the mobile telephone 12 of user 1 can be carried out through a voice synthesis automatic system of a known kind comprised into at least one computer 15 connected to computer 10. Also the control of the availability of amount P with the credit holder 13 can be carried out through a known automatic system comprised into at least one computer 16 which is connected to computer 10 and can connect to at least one computer 17 of the credit holder 13 through network 3, or, in other embodiments of the present invention, through a dedicated data line or a private LAN or WAN network.

If user 1 answers positively to the confirmation request through his mobile telephone 12, broker 9 asks the credit holder 13 to debit user 1 with amount P and to credit seller 4 with the same amount, reduced with a service charge, if desired. User 1 can answer to broker 9 in different ways, for instance by means of a text message via SMS, one or more DTMF tones associated with the keys of the mobile telephone 12, and/or a voice message recognized by a known voice recognition system installed into computer 15.

Broker 9 then communicates to seller 4, through computers 5, 10 and network 3, the occurred order confirmation of user 1, so that seller 4 can supply the latter with item or service 6. If instead the credit holder 13 does not confirm the availability of amount P, user 1 does not confirm the order through telephone 12 or anyway user 1 is not debited with amount P for any other reason, broker 9 communicates the order cancellation to seller 4.

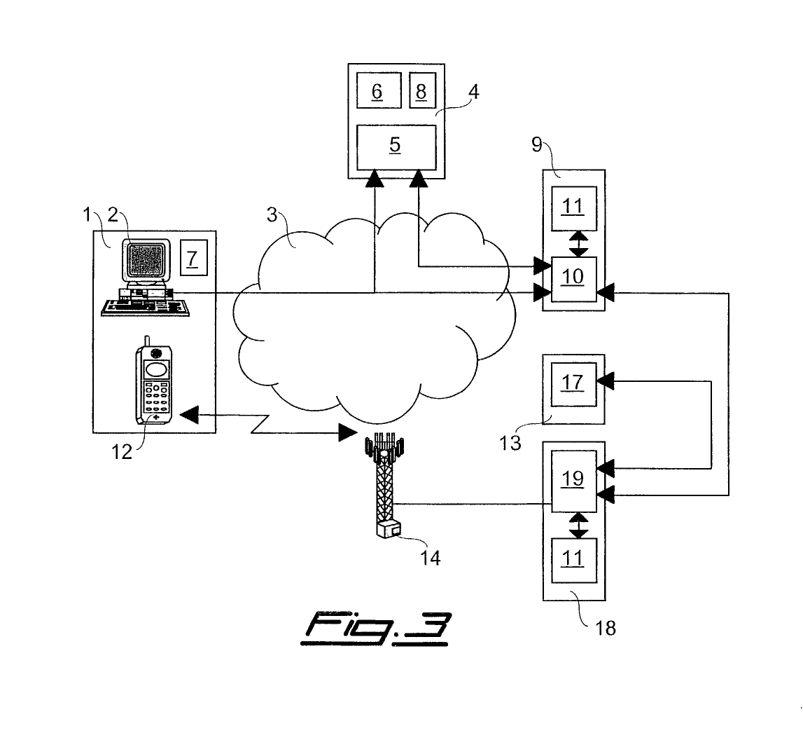

Referring to FIG. 3, it is seen that in a second embodiment of the system according to the present invention, a second broker 18, besides broker 9, is present, which is provided with at least one computer 19 connected to a computer of the first broker 9. In the present embodiment of the invention, computer 19 of the second broker 18 is connected to computer 10 of the first broker 9 through a dedicated line, but it is obvious that in other embodiments the connection between the two brokers 9, 18 can be carried out with different computers and/or lines. Computer 19 of the second broker 18 is also connected to the mobile telephone network 14, to a copy of database 11, as well as to computer 17 of the credit holder 13, for instance through a dedicated line.

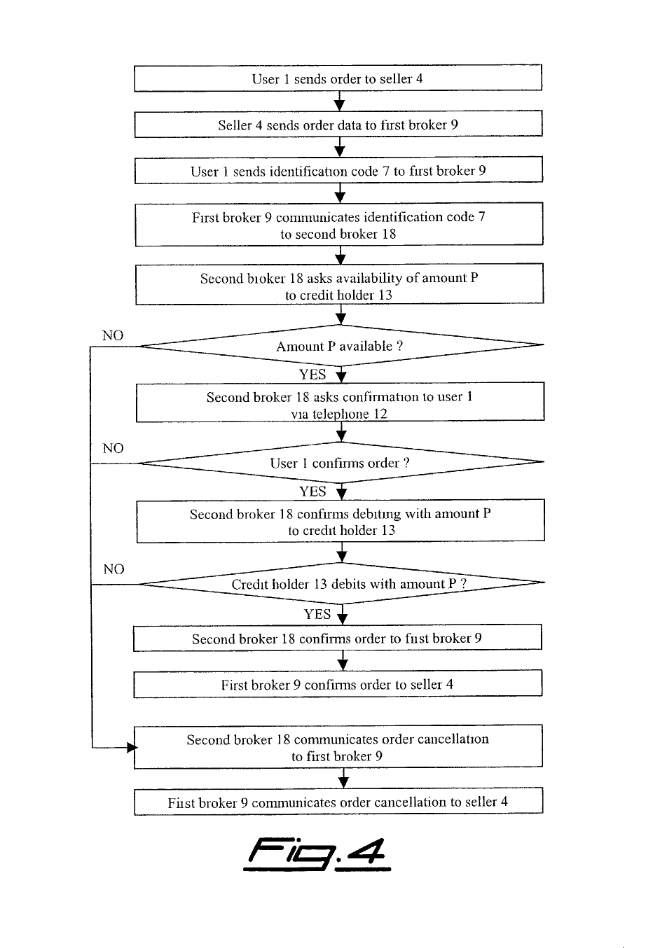

Referring to FIG. 4, it is seen that in the process that carries out this second embodiment of the invention, the first broker 9, once he receives the data from seller 4 and the identification code 7 from user 1, sends through his own computer 10 to the second broker 18 the data of user 1, in particular the identification code 7 or his telephone number, obtained from database 11. The second broker 18, which can be for instance a mobile radio telephone provider, preferably asks the availability of amount P to the credit holder 13 and, in the positive case, asks the order confirmation to user 1 through his mobile telephone 12 in the above described way. If user 1 answers positively, the second broker 18 requests the debiting of amount P to the credit holder 13 and, if the transaction is successful, communicates the order confirmation to the first broker 9. The latter then communicates to seller 4 the confirmation or the cancellation of the order of item or service 6 through network 3. In this embodiment of the invention the first broker 9 therefore acts as a “network interface” between the distributed data network 3 and the second broker 18.

In an alternative embodiment of the invention, the credit holder is the same second broker 18, in particular the same mobile telephone provider which issued the SIM card of the mobile telephone 12 of user 1. This card is suitably associated with a credit account, from which the second broker 18 can directly draw amount P of item or service 6. Said credit account does preferably not coincide with the account employed for paying the calls carried out with telephone 12.

Finally, it is obvious that the data exchanged between the computer of user 1, seller 4 and/or brokers 9, 18 can be encrypted for further increasing the security level of the process and the system according to the present invention.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. Process for purchasing goods and services (6) through a distributed data network (3), which comprises the following operative steps:
a computer (5) of a seller (4) receives an order of at least one item or service (6) from a device (2) of a user (1) for accessing to the distributed data network (3);
a computer (5) of the seller (4) sends through the distributed data network (3) data (P) of the item or service (6) ordered by the user (1) to a computer (10) of a broker (9);
characterized in that it comprises the following further operative steps:
the access device (2) of the user (1) sends at least one identification code (7) of the user (1);
a computer (10; 19) of a broker (9; 18) receives the identification code (7) of the user (1) and obtains from a database (11) the number of a mobile telephone (12) according to said identification code (7);
a computer (15; 19) of a broker (9; 18) dials the number obtained from the database (11) and calls the relevant mobile telephone (12) through a mobile telephone network (14);
a computer (15; 19) of a broker (9; 18) asks for a confirmation of said order of the user (1) through the called telephone (12);
a computer (10) of a broker (9) sends through the distributed data network (3) a confirmation or a cancellation of the order of the user (1) to a computer (5) of the seller (4) according to the answer, if any, obtained through the called telephone (12).

2. Process according to claim 1, characterized in that said computer (15; 19) of a broker (9; 18) calls the mobile telephone (12) of the user (1) after the following further operative steps:
a computer (16; 19) of a broker (9; 18) connects to a computer (17) of a credit holder (13) and requests the availability of an amount (P) in a credit account of the user (1) according to the data (P) of the item or service (6) ordered by the user (1) sent by said computer (5) of the seller (4);a computer (17) of the credit holder (13) communicates the availability, if any, of said amount (P) in the credit account of the user (1) to a computer (16; 19) of a broker (9; 18).

3. Process according to claim 2, characterized in that said computer (10) of a broker (9) sends the confirmation or the cancellation of the order of the user (1) to a computer (5) of the seller (4) after the following further operative steps:
a computer (16; 19) of a broker (9; 18) connects to a computer (17) of a credit holder (13);
said computer (16; 19) of the broker (9; 18) asks said computer (17) of the credit holder (13) to debit the user (1) with said credit amount (P);
said computer (16; 19) of the broker (9; 18) waits from said computer (17) of the credit holder (13) for the confirmation, if any, of said debiting of the user (1).

4. Process according to claim 3, characterized in that the amount (P) debited to the user (1) by the credit holder (13) corresponds with one or more data (P) of the item or service (6) ordered by the user (1), which have been sent by the computer (5) of the seller (4).

5. Process according to claim 4, characterized in that the seller (4) is credited by the credit holder (13) with the amount (P), if desired reduced with a service charge, which is debited to the user (1) by the credit holder (13).

6. Process according to claim 1, characterized in that the computer (19) of the broker (18) which obtains from the database (11) the number of the mobile telephone (12) of the user (1) receives his identification code (7) from a computer (10) of another broker (9) connected to the distributed data network (3).

7. System for purchasing goods and services (6) through a distributed data network (3), which comprises at least one computer (10) of a broker (9) suitable for receiving through the distributed data network (3) from a computer (5) of a seller (4) data (P) of an item or service (6) ordered by a user through the distributed data network (3);
characterized in that it also comprises:
a computer (10; 19) of a broker (9; 18) suitable for receiving an identification code (7) of the user (1) and obtaining from a database (11) connected to it the number of a mobile telephone (12) according to said identification code (7);
a computer (15; 19) of a broker (9; 18) suitable for dialing the number obtained from the database (11), calling the relevant mobile telephone (12) through a mobile telephone network (14) and asking a confirmation of the order of the user (1) through the called telephone (12);
a computer (10) of a broker (9) suitable for sending through the distributed data network (3) a confirmation or a cancellation of the order of the user (1) to a computer (5) of the seller (4) according to the answer, if any, obtained through the called telephone (12).

8. System according to claim 7, characterized in that it also comprises a computer (16; 19) of a broker (9; 18) suitable for connecting to a computer (17) of a credit holder (13) and requesting the availability or the debiting of an amount (P) in a credit account according to data (P) of the item or service (6) ordered by the user (1), said data (P) being sent by said computer (5) of the seller (4).

9. System according to claim 8, characterized in that the data for accessing the credit account of the user (1) with the credit holder (13) are associated in said database (11) with the identification code (7) of the user (1).

10. System according to claim 7, characterized in that said confirmation request of the order of the user (1) through his telephone (12) consists in a message which is sent by said computer (15; 19) of a broker (9; 18) and contains data (P) of the item or service (6) ordered by the user (1).

11. System according to claim 10, characterized in that said computer (15; 19) of a broker (9; 18) suitable for asking a confirmation of the order of the user (1) through his telephone (12) comprises means for generating, sending, receiving and interpreting SMS text messages.

12. System according to claim 10 , characterized in that said computer (15; 19) of a broker (9; 18) suitable for asking a confirmation of the order of the user (1) through his telephone (12) comprises means for generating, sending, receiving and interpreting voice messages.

13. System according to claim 7, characterized in that the mobile telephone (12) of the user (1) comprises a SIM card, associated with the credit account from which the amount (P) is drawn according to the data (P) of the item or service (6) ordered by the user, which are sent by said computer (5) of the seller (4).

14. System according to claim 7, characterized in that the computer (19) of the broker (18) which obtains from the database (11) the number of the mobile telephone (12) of the user (1) is suitable for connecting to a computer (10) of another broker (9) connected to the distributed data network (3).

15. System according to claim 14, characterized in that the computer (10) of the first broker (9) and the computer (19) of the second broker (18) are mutually connected by means of a dedicated data line or a private data network.
